(19) United States
(12) Patent Application Publication
(10) Pub. No.: US 2005/0217601 A1
(43) Pub. Date: Oct. 6, 2005

(54) Dogwash

(76) Inventor: Gregory Alan Judge, Vallejo, CA (US)

Correspondence Address: THOMAS R. LAMPE;BIELEN, LAMPE & THOEMING, 1390 WILLOW PASS ROAD, SUITE 1020, CONCORD, CA, 94520, US

(21) Appl. No.: 10/784,011

(22) Filed: Feb. 23, 2004

(51) Int. Cl. A01K 13/00

(52) U.S. Cl. 119/665

(57) ABSTRACT

The invention pertains to a hand-held pet bathing utensil that incorporates a nozzle consisting of an array of rigid tubular extensions that can deliver water directly to the animal's skin. This action displaces the entrapped air in the animal's fur coat that acts as insulation, thereby quickly and easily saturating the fur coat and substantially reducing the effort in pet bathing previously required. The utensil can be connected to a garden hose or a shower and it's proportional flow regulating valve conserves water and energy and allows the user to efficiently bathe their pet with warm water, indoors or out.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The present invention relates to a water dispensing bathing utensil for pet animals incorporating a nozzle comprised of rigid tubular extensions which distribute water to the base of the animal's fur coat and thereby directly to the skin of the animal.

Prior art includes dozens of patented inventions designed to make easier the chore of bathing pet animals which need to be bathed periodically however, none of them have addressed the predominant factor which creates the difficulty. Mammalian fur naturally entraps air next to the animals skin. This layer of air is the insulation that enables mammals to comfortably survive in virtually all climates on Earth. Horses and cattle can stand in direct sunlight every day during the hot summer months while, dogs and polar bears can swim in ice-cold water for hours at a time, all the while enjoying completely dry skin.

Pet bathing utensils which incorporate brushes and/or bristles are no more efficient than the numerous patented animal body enclosure machines that contain showering mechanisms. They can at best only align and compress the fur coat but not allow the entrapped air to escape and, in practice, become entangled so badly as to increase the difficulty. Common spray nozzles such as conventional shower heads and garden/lawn sprayers are the most popularly accepted tools for pet bathing but are inefficient for they apply water to the fur coat externally.

Water applied externally to the fur coat, whether from a shower nozzle, a river or lake, or rain is one of the things that nature designed the fur coat to defend against and thereby protect the animal. Water applied externally is repelled unless it is applied under substantial pressure. Pressurized water applied externally creates splash and over-spray that will startle, annoy and spook the animal causing the animal to resist, often violently. Over-spray and splash also effect the user, adding to the discomfort and difficulty. Pet bathing is universally considered unpleasant for animals and owners alike.

### BRIEF SUMMARY OF THE INVENTION

The invention is a hand-held pet animal bathing utensil which connects to a flexible water supply line and incorporates a proportional flow regulating valve and a nozzle comprised of an array of rigid tubular extensions that terminate in a common plane or arc and are of sufficient length to penetrate the animal's fur coat in order to deliver water to the base of the fur coat and thereby the animal's skin and thereby displace the naturally entrapped air which serves as an insulation layer in order to quickly and efficiently saturate the animal's fur coat while virtually eliminating splash and over-spray. The object being to greatly improve the state of the art in pet animal bathing.

### BRIEF DESCRIPTION OF THE SEVERAL VIEWS OF THE DRAWINGS

FIG. 1 is a side view of a hand-held pet animal bathing utensil.

FIG. 2 is a bottom view of a hand-held pet animal bathing utensil.

### DETAILED DESCRIPTION OF THE INVENTION

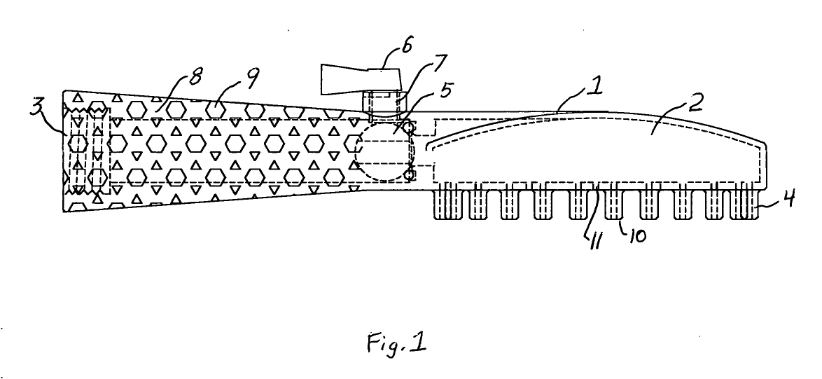

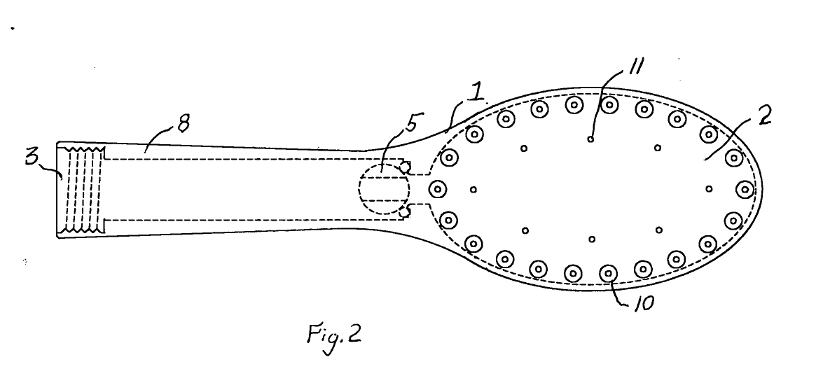

The preferred embodiment of the pet animal bathing utensil can be seen in FIGS. 1 and 2 comprised generally of an outer housing 1 containing a hollow water conduit chamber 2 which extends from the water supply port 3, a standard female garden hose thread or the like, entirely through the utensil to the nozzle 4.

Between the water supply port 3 and the nozzle 4 the hollow water conduit chamber 2 contains a proportional flow regulating valve 5, a standard ball valve or the like. The valve 5 is in communication with an external handle 6 through a port 7 in the outer housing 1 which allows the user to actuate the valve externally.

FIG. 1 depicts the utensil's handgrip 8 is treated with a non-slip surface 9.

The nozzle 4 consists of an array of rigid tubular extensions 10 that extend from the outer housing 1 and are in communication with the hollow water conduit chamber 2 and terminate in a common plane or arc at a distance from the outer housing 1 which allows them to extend through a pet animals fur coat and allow the transfer of water to the animal's skin and the base of said fur coat These rigid tubular extensions 10 are spaced so as to be easily drawn through the animals fur coat without becoming entangled in said fur coat and whereby the saturating flow pattern from each rigid tubular extension 10 will overlap the flow pattern of it's adjacent members.

The nozzle 4 of the preferred embodiment also consists of an array of ports 11 through the outer housing 1 located within the array of rigid tubular extensions 10 which allows the transfer of water to the outside of the animal's fur coat.

It can be seen that by opening the valve 5 pressurized water from a standard household plumbing connection is allowed to pass freely from the supply port 3 through the hollow water conduit chamber 2 and exit simultaneously through the rigid tubular extensions 10 and the ports 11, thereby when the utensil is drawn through a pet animal's fur coat it can quickly and easily completely saturate said fur coat.

The utensil can be easily and inexpensively constructed of rigid plastic with conventional injection molding processes.

The utensil can be connected to a standard garden hose which is attached to a standard outdoor household water spigot for outdoor warm weather use. Also, the garden hose can be attached to a warm water supply such as a household sink faucet by use of a simple, readily available, threaded adapter for cold weather use. Also, the utensil can be connected to bathroom shower supply line for indoor use by utilizing a standard hand-held shower's flexible hose and adapter.

The utensil's nozzle 4 is applied to the animal while the user opens and adjusts the valve 5 to a comfortable flow. This can be accomplished with only one hand so the other hand is free to restrain and/or reposition the animal. Gently passing the utensil's nozzle 4 through the animal's fur coat introduces water to the base of the fur coat, displacing the entrapped air which is the animal's natural insulation. Once the fur coat is saturated, the utensil can be turned off by closing the valve 5, thereby conserving water and any energy involved in heating the water. Once the animal is lathered and scrubbed, the utensil is re-applied to the animal to quickly and efficiently displace the lather and clean rinse the animal.

During the bathing process the animal remains at a substantially higher comfort level than allowed by the prior art because, the utensil's rigid tubular extensions 10 create a cushion of water over the animal's skin which virtually eliminates friction between the utensil and the animal.

The present embodiment of the invention incorporates ports 11 that not only direct part of the flow of water to the outside of the fur coat to facilitate total saturation of said coat but, also serve to relieve internal pressure in the utensil should the rigid tubular extensions 10 be applied to the animal with too much force, thus enabling the user to easily maintain the proper “touch.”

Water disbursed by the rigid tubular extensions 10 is exhausted through the animal's fur coat around the perimeter of the nozzle 4, thereby significantly reducing the pressure and velocity of the flow which enables gravity to direct the excess water down the side of the animal until it reaches the animal's underbelly where it falls gently to the ground. This action helps to keep the animal calm and the user dry.

1-5. (canceled)

6. A handheld pet animal bathing utensil for connection to a source of pressurized water through a hose or other supply line and for simultaneously delivering a plurality of streams of flowing water to an animal's fur coat, some of said streams delivered to the base of the animal's fur coat and other of said streams simultaneously delivered to the outer portion of the animal's fur coat, to displace entrapped insulation air in the animal's fur coat and effectively bathe the animal, said utensil including a housing defining a chamber for receiving water from said source of pressurized water, said housing having an outer periphery and having a substantially planar housing surface with an inner housing surface portion and an outer peripheral housing surface portion bounded by said outer periphery surrounding said inner housing surface portion, said substantially planar housing surface defining an array of spaced water exit ports in fluid flow communication with said chamber and located within said inner housing surface portion in a first common plane occupied generally by said substantially planar housing surface, and said utensil further including an array of elongated, spaced, rigid tubular extensions projecting outwardly from said outer peripheral housing surface portion and in fluid flow communication with said chamber, said elongated, spaced, rigid tubular extensions being rigid over the entire lengths thereof and having parallel primary axes disposed orthogonally relative to said substantially planar housing surface and further having distal ends, said array of elongated, spaced, rigid tubular extensions positioned along the entire length of said outer periphery of said housing surrounding the array of spaced ports, and said elongated, spaced, rigid tubular extensions being free of openings along the sides thereof and having water discharge openings formed in said distal ends spaced from said ports and disposed generally in a second common plane spaced from and disposed outwardly of said first common plane and said ports, said elongated, spaced, rigid tubular extensions being of sufficient length to penetrate the animal's fur coat and deliver water from said chamber to the base of the animal's fur coat through the water discharge openings in the distal ends thereof in directions co-axial with the primary axes when said ports deliver water from said chamber to the outer fur coat, and said elongated, spaced, rigid tubular extensions operable to create a cushion of water over the animal's skin reducing friction between the utensil and the animal and cooperable with the animal's fur coat to reduce pressure and velocity of water after exiting said ports and water discharge openings at the distal ends to reduce splashing and enabling gravity to direct excess water from the bathing utensil down a side or sides of the animal, said ports operable to relieve water pressure in said chamber when the water discharge openings at the distal ends of the elongated, spaced, rigid tubular extensions are blocked, said handheld pet animal bathing utensil additionally including a control valve operatively associated with said housing for controlling water flow through said water exit ports and said water discharge openings.
